(19) United States
(12) Patent Application Publication
(10) Pub. No.: US 2017/0035216 A1
(43) Pub. Date: Feb. 9, 2017

(54) CUSHIONING DEVICE

(71) Applicant: Carmel Technology Group, Inc., Charlotte, NC (US)

(72) Inventors: Kirk L. MacKenzie, Charlotte, NC (US); Allen Siekman, Ben Lomond, CA (US)

(21) Appl. No.: 15/223,104

(22) Filed: Jul. 29, 2016

Related U.S. Application Data
(60) Provisional application No. 62/200,149, filed on Aug. 3, 2015.

(51) Int. Cl. A47C 31/11; A47C 31/10; A61G 5/10; A47C 7/02; A47C 7/18

(52) U.S. Cl. CPC A47C 31/116; A47C 7/021; A47C 7/022; A47C 7/18; A61G 5/1043; A61G 5/1002; A47C 31/105; A61G 2005/1045

(57) ABSTRACT

A cushioning device for supporting a user in seated or recumbent posture, e.g., in a wheelchair, comprises a resiliently compressible foam base layer with an upper surface formed of a configuration generally conforming to the user's body and defining a fluid drainage path to a fluid drainage and collection area in case of incontinence episodes, an absorbent layer disposed in association with the fluid collection area for collection and holding fluids draining to the collection area, a fluid-impermeable bottom layer covering the underside of the base layer, and a non-absorbent top layer covering the upper surface of the base layer. Together, the fluid permeability and non-absorbent character of the top layer and the compressible resiliency and drainage configuration of the foam base layer for draining fluids to the absorbent layer, mitigate pressure, heat, moisture, shear and friction conditions that are the main contributing causes to formation of decubitus ulcers.

### BACKGROUND OF THE INVENTION

The present invention relates generally to cushions used for supporting a person's body in a seated or recumbent position and, more particularly, to cushions to prevent or relieve the causes and symptoms of decubitus ulcers.

Decubitus ulcers, also often referred to as pressure sores, pressure ulcers or bed sores, occur in localized areas of skin and flesh, usually over a bony prominence or area, subjected over an extended period of time to “microclimate” conditions of unrelieved pressure, heat, moisture, shear forces and/or friction. The hips and buttocks are common areas at which decubitus ulcers often occur, as a result of prolonged periods of sitting. Undue pressure on the affected area, especially in the presence of heat, moisture, shear and/or friction, are the main causes of decubitus ulcers. At-risk individuals, such as elderly and disabled persons who spend long periods of inactivity in a seated or recumbent position, e.g, in a wheelchair, are especially subject to decubitus ulcers.

Decubitus ulcers typically progress in stages, initially as discolored areas of skin, often appearing as bruises, progressing if untreated into open sores deep into the underlying tissue. Early treatment can be successful with medication, but progressed stages can require invasive surgery. As with many medical conditions, however, prevention is more advisable and advantageous than treatment.

### SUMMARY OF THE INVENTION

The present invention accordingly seeks to address the problems of decubitus ulcers by providing a cushioning device of a novel structure that can be used for support and skin protection by disabled, elderly and other at-risk persons who may be confined to a wheelchair or bedridden or whose activity level or mobility is otherwise restricted, making them prone to the development of such ulcers.

Briefly summarized, the cushioning device of the present invention comprises a base layer comprised of one or more layers or segments of foam, and having upper and lower surfaces. The lower surface of the base layer is of a configuration for resting on a load bearing surface, and the upper surface is of a configuration generally conforming to the body and defining a fluid drainage path to a fluid collection area. An absorbent layer is disposed in association with the fluid collection area for collecting and holding fluids draining to the fluid collection area of the base layer. A bottom layer covers the lower surface of the base layer, and comprises a substantially fluid-impermeable material for retaining fluids from leaking from the absorbent layer. A top layer covers the upper surface of the base layer, and comprises a fabric formed of predominately non-absorbent yarns in a fluid permeable fabric structure for relatively free passage of fluids through the top layer to the base layer. Together, the fluid permeability and non-absorbent character of the top layer and the compressible resiliency and drainage configuration of the foam base layer for draining fluids to the absorbent layer, mitigate pressure, heat, moisture, shear and friction conditions that are the main contributing causes to formation of decubitus ulcers.

In contemplated embodiments of the cushioning device, a plurality of drainage openings may extend between the fluid collection area and the lower surface, and the absorbent layer may be disposed between the lower surface of the base layer and the bottom layer beneath the drainage openings for collecting and holding fluids passing through the top layer, the fluid collection area, and the drainage openings. The base layer may comprise a recess in the lower surface beneath the fluid collection area for receiving the absorbent layer. In other embodiments, the absorbent layer may be disposed within the fluid collection area, whereby drainage openings may not be needed in the fluid collection area.

The foam of the base layer may advantageously be of a cell structure substantially without affinity for fluid absorption or containment within the base layer. For example, the foam of the base layer may comprise a predominately closed cell foam, such as an ethylene-vinyl acetate foam.

A plurality of layers of a spacer fabric may overlie the upper surface. Each layer of the spacer fabric has upper and lower fabric plys formed of predominately non-absorbent yarns in a fluid permeable fabric structure and an array of spacer segments formed of predominately non-absorbent yarns extending between the upper and lower plys and urging the upper and lower plys into spaced relationship to one another. The spacer fabric layers thereby permit relatively free passage of fluids through the spacer fabric layers to the upper surface of the base layer. The spacer fabric layers may comprise four or more layers of a spacer fabric. The top and bottom layers may be removable for cleaning.

In contemplated embodiments, the base, spacer fabric, absorbent, top and bottom layers may be collectively configured as a seat cushion device for use on a chair seat or, alternatively, may be configured as a mattress device for use on a bed.

For example, the upper surface of the base layer may have a profiled configuration which comprises a recess configured for resting receipt of hips and thighs of the body, spaced-apart convergingly inclined lateral hip support surfaces and a forward upper thigh support surface extending between forward ends of the hip support surfaces, with the fluid collection area disposed rearwardly of the upper thigh support surface and between rearward ends of the hip support surfaces, and with the fluid collection area at a lower elevation than the upper thigh support surface and the hip support surfaces for receiving ischial tuberosities of the body when seated thereon. In contemplated embodiments, the lateral hip support surfaces may be formed with one or more recessed areas to promote air flow to and from the upper surface of the base layer and the spacer fabric layers disposed thereon.

### BRIEF DESCRIPTION OF THE DRAWINGS

FIG. 1 is an overall perspective view of a cushioning device according to one contemplated embodiment of the present invention;

FIG. 2 is a perspective view of the cushioning device of FIG. 1 depicting the individual components thereof in exploded form;

FIG. 3 is a vertical cross-sectional view of the cushioning device of FIG. 1, taken lengthwise therethrough along line 3-3 of FIG. 1;

FIG. 4 is another vertical cross-sectional view of the cushioning device of FIG. 1, taken laterally therethrough along line 4-4 of FIG. 1;

FIG. 5 is another vertical cross-sectional view of the cushioning device of FIG. 1, taken laterally therethrough along the line 5-5 of FIG. 1; and

FIG. 6 is a perspective view of a cushioning device according to another contemplated embodiment of the present invention, depicting the individual components thereof in exploded form.

### DETAILED DESCRIPTION OF THE INVENTION

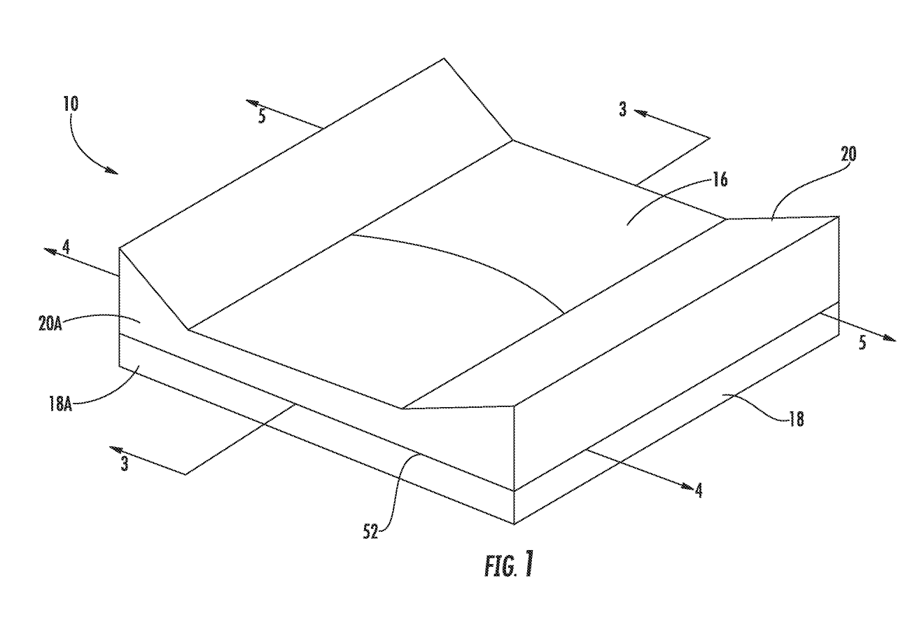

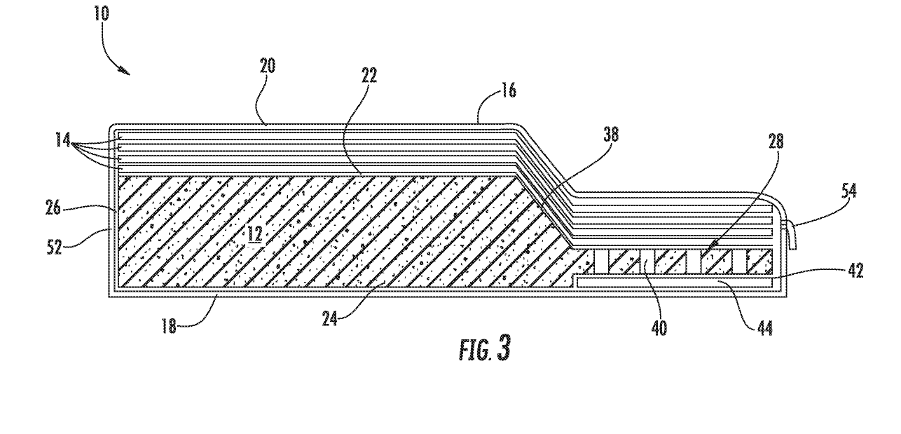

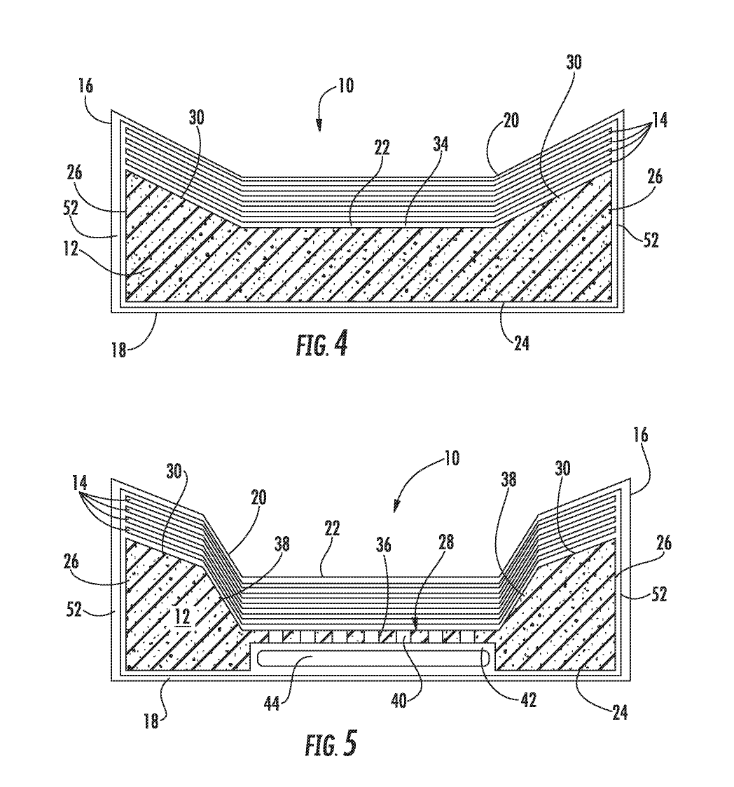

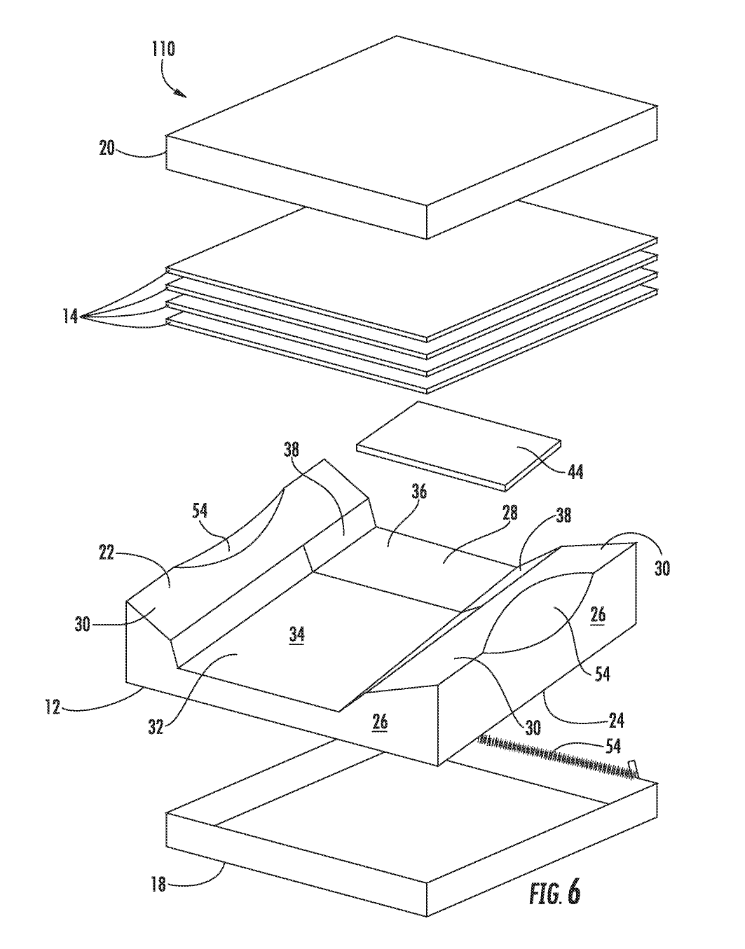

Referring now to the accompanying drawings and initially to FIGS. 1-5, a cushioning device in accordance with the present invention is depicted overall at 10 in FIG. 1 in one contemplated embodiment particularly adapted for use as a seat cushion for a wheelchair or other seating surface. However, it is to be expressly understood that the cushioning device of the present invention is not limited to embodiment in seat cushions, but is intended and contemplated to be of a substantially broader utility adaptable to other forms of body cushions to provide cushioning support to a user's body while supported in differing postures on differing load bearing surfaces, e.g., in addition to seat cushions for supporting a body in a seated position, mattresses and like larger cushions for supporting all or a portion of a body in a recumbent posture, and any other cushion used to provide cushioning support to a user while resting on a load bearing surface.

The cushioning device 10 in the illustrated embodiment is of a generally rectangular or square overall configuration comprised basically of a main central interior base layer 12, preferably in the form of a body of a foam material, and a plurality of interior fabric layers 14, preferably formed of a spacer fabric material overlying the base layer 12, the base and spacer fabric layers 12, 14 being enclosed within an outer covering 16. The outer covering 16 is comprised of a bottom layer 18 underlying the base layer 12, preferably formed of a substantially fluid-impermeable material, and a top layer 20 overlying the spacer fabric layers 14, preferably formed of a fluid permeable fabric or like material, with the bottom and top layers 18, 20 of the covering 16 joined together along the sides of the base layer 12 around the full perimeter thereof to fully enclose the base and spacer fabric layers 12, 14.

The base layer 12 is preferably a unitary body of foam material, which may comprise, for example, a monolithic body of a compressible resilient foam or a foam body comprised of multiple layers or segments of different types of foam materials, which could include layers or segments of both resilient and non-resilient foams forming an overall compressible resilient foam body. The base layer 12 is preferably formed in an overall rectangular or square configuration having opposed spaced-apart upper and lower surfaces 22, 24, respectively, joined by outer side surfaces 26 extending vertically therebetween. The lower surface 24 of the base layer 12 is preferably of a generally flat configuration to facilitate horizontal resting on a load bearing seating support surface such as the seat portion of a wheelchair. The upper surface 22 of the base layer 12 is preferably formed with a profiled configuration defining a body recess to generally conform to a user's body, particularly the buttocks, hips and thighs of a user when seated, while also defining a fluid drainage path to a fluid collection area 28 centrally and rearwardly within the base layer 12, e.g., for the drainage of urine in the case of an incontinent user.

More specifically, the upper surface 22 of the base layer 12 has laterally outward hip support surface portions 30 which extended angularly downwardly in converging relation to a generally horizontal central region 32 of the base layer 12. The forward portion 34 of the central region 32 forms a support surface for a user's upper thighs while the rearward portion 36 of the central region 32 forms the fluid collection area 28. The forward portion 34 is more elevated than the rearward portion 36, with additional angled surfaces 38 extending downwardly from the lateral hip support and forward portions 30, 34 to the rearward portion 36 to direct fluid drainage. The fluid collection area 28 defined by the rearward portion 36 of the central region 32 is formed with a plurality of openings 40 to direct drainage of fluid to the bottom side of the base layer 12 away from the user. The lower surface 24 of the base layer 12 is preferably formed with a rectangular recess 42 immediately beneath the fluid collection area 28 to support an absorbent pad 44, such as any of various conventional forms of incontinent pads, to collect and hold drained fluid.

The base layer 12 provides the main cushioning structure to the device 10 and therefore is preferably formed of a resiliently compressible foam, but most preferably a foam material substantially without affinity for absorbing or containing fluid. It is contemplated that any of various known forms of compressibly resilient foam material may be utilized. For example, but without limitation, it is presently contemplated that a foam material of a predominantly closed cell structure, such as an ethylene-vinyl acetate foam, will provide a satisfactory balance of compressible resilience to promote user comfort without undue spots of isolated pressure on a user's body while also facilitating fluid drainage with minimal or at least limited absorption or containment of fluid.

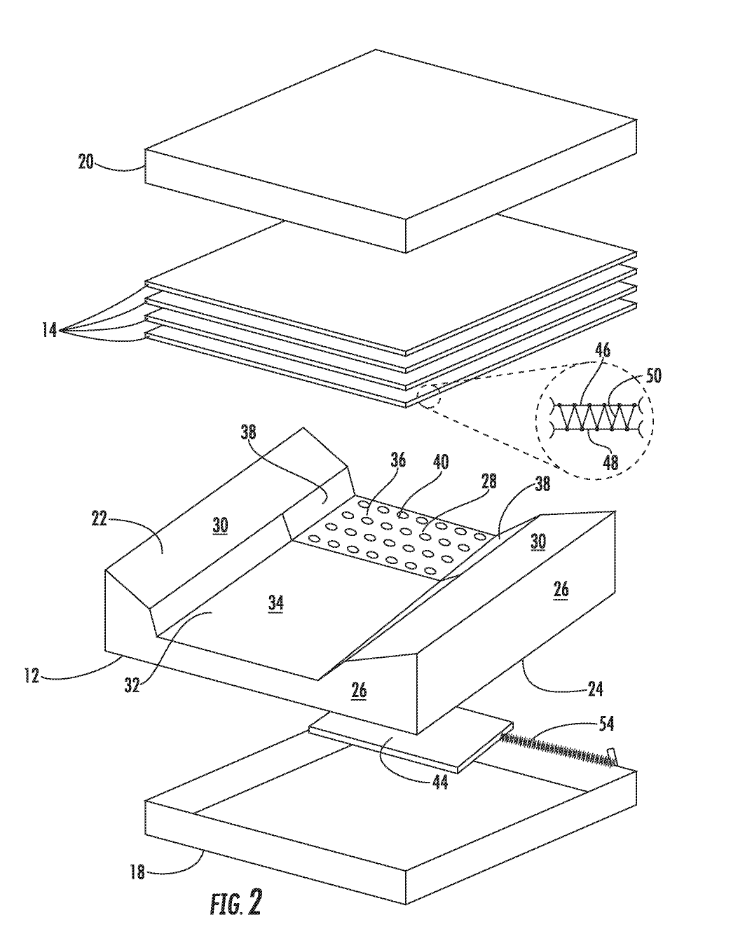

Spacer fabrics of the basic type used for the layers 14 are known within the textile industry and find use in various and diverse applications. As representatively depicted in FIG. 2, each spacer fabric layer 14 basically comprises an integral fabric structure formed of upper and lower fabric plies 46, 48 with connecting spacer segments 50 extending therebetween and urging the fabric plies 46, 48 apart in spaced generally parallel relationship. Any of various forms of known spacer fabrics may be suitable for use in the cushioning device 10 of the present invention. It is presently contemplated to be preferred that the spacer fabric layers 14 be formed of textile yarns that are predominantly non-absorbent yet provide strength and resiliency, e.g., filamentary polyester, interconnected in an openwork fabric structure, such as a warp knitted fabric structure of a relatively coarse gauge stitch count, to promote substantially free permeability and passage of liquid and gas so as to promote fluid drainage as well as dissipate heat away from the user. As presently contemplated, four spacer fabric layers 14 are utilized in the present cushioning device 10, but a lesser or greater number of spacer fabric layers are also possible. All of the spacer fabric layers 14 may be formed of the identical spacer fabric structure, or selectively differing spacer fabrics could be utilized among the differing layers to promote particular fluid drainage and heat dissipation characteristics.

The outer covering 16 is fabricated to fully enclose the base and spacer fabric layers 12, 14 in close containment to retain their layered relationship and impart structural integrity to the overall cushioning device 10. The bottom layer 18 contains the entire lower portion of the base layer 12 and is necessarily of a substantially fluid-impermeable material to retain drained fluid within the cushioning device against undesirable leakage from the fluid collection area 28 and the absorbent pad 44. Any of various known materials may be suitable as the bottom layer 18, but presently it is contemplated that a vinyl or similar polymeric film material may be best suited for secure fluid containment.

The top layer 20 of the outer covering 16 will be in direct contact with a user and therefore should be of a material that promotes comfortable non-frictional body contact without containment of body heat while also being nonabsorbent as well as sufficiently permeable to allow unimpeded passage of fluids into the cushioning device 10 for collection and containment. Any of various textile fabrics commonly used in apparel fabrication are contemplated to be suitable as the top layer 20, for example, a knitted polyester fabric.

Each of the bottom and top layers 18, 20 are fabricated to extend respectively over the entirety of the upper and lower extents of the base and spacer fabric layers 12, 14, with a margin 18A, 20A of both layers 18, 20 extending toward each other over the side surfaces 26 and joined together about the full perimeter of the device 10 as indicated at 52. Preferably, the joinder of the bottom and top layers 18, 20 is in a form allowing the outer covering 16 to be removed for laundering and also allowing access to the absorbent pad 44 for disposal. For example, the margins 18A, 20A of the layers 18, 20 may be sewn together along three side surfaces 26 but separable along a fourth side surface 26, such as by mating sides of a zipper 54 or mating lengths of a hook and loop fastener.

In use, the cushioning device 10 fits neatly over the seat section of a wheelchair (or alternatively any other chair or seat) to provide comfortable body-contoured cushioning and skin protection to a user. In particular, the profiled configuration of the upper surface 22 of the base layer 12 imparts a correspondingly profiled configuration to the overall upper surface of the device 10, whereby the central region 32 of the base layer 12 provides support to the upper thighs and buttocks of a user and the angled lateral surfaces 30 provide support to the user's hips while the ischial tuberosities of the user's body are received within the lower elevation of the fluid collection area 28 at the rearward portion 36 of the base layer 12. In this manner, the configuration of the cushioning device 10 provides substantially uniform cushioning support to the contacting portions of the user's body to help mitigate pressure conditions that contribute to decubitus ulcers. At the same time, the anti-frictional character of the top layer 20 contributes to reducing frictional and shear forces on the user's skin, and the porosity of the top layer 20 and the spacer fabric layers 14 promote airflow to similarly help mitigate overheating and moisture conditions adjacent the user's body that also contribute to decubitus ulcers. As occasional incontinence of wheelchair confined users is not uncommon, the profiled configuration of the base layer 12 together with the permeability of the top layer 20 and the spacer fabric layers 14 serves to direct any urine resulting from an incontinence episode away from the user with minimal retention of moisture in contact with the user's body and to collect the fluid for subsequent disposal, all of which further helps to mitigate moisture conditions that contribute to decubitus ulcers.

Many embodiments and adaptations of the present invention other than those herein described, as well as many variations, modifications and equivalent arrangements will be apparent from or reasonably suggested by the present invention and the foregoing description thereof, without departing from the substance or scope of the present invention. For example, an alternative embodiment of the cushioning device of the present invention is indicated overall at 110 in FIG. 6, wherein like components of the cushioning device are otherwise identified by like reference numerals as in FIGS. 1-5. The cushioning device 110 is substantially similar to the embodiment of FIGS. 1-5, but with the absorbent pad 44 disposed on the upper surface 22 of the base layer 12 within the fluid collection area 36 of the base layer 12 which eliminates or mitigates the need for drainage openings 40 between the fluid collection area 36 and the lower surface 24. Also, the upper surface 22 of the base layer 12 is formed with arcuate recesses 54 centrally within the lateral hip support surfaces 30 which promotes air exchange across and within the upper surface 22 and within the spacer fabric layers 14 to assist in mitigating moisture and heat within the cushioning device 110, while still retaining hip support surfaces 30 at the corners of the cushioning device 110.

It will therefore be readily understood by those persons skilled in the art that the present invention is susceptible of a broad utility and application. Accordingly, while the present invention has been described herein in detail in relation to contemplated embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiment, adaptations, variations, modifications and equivalent arrangements, the present invention being limited only by the claims appended hereto and the equivalents thereof.

What is claimed is:

1. A device for cushioning support of a body in seated or recumbent posture on a load bearing surface, comprising:
a base layer comprised of one or more layers or segments of foam, and having upper and lower surfaces, the lower surface being of a configuration for resting on a load bearing surface, the upper surface being of a configuration generally conforming to the body and defining a fluid drainage path to a fluid collection area,
an absorbent layer disposed in association with the fluid collection area for collecting and holding fluids draining to the fluid collection area of the base layer,
a bottom layer covering the lower surface of the base layer, the bottom layer comprising a substantially fluid-impermeable material for retaining fluids from leaking from the absorbent layer, and
a top layer covering the upper surface of the base layer, the top layer comprising a fabric formed of predominately non-absorbent yarns in a fluid permeable fabric structure for relatively free passage of fluids through the top layer to the base layer.

2. A device for cushioning support of a body in seated or recumbent posture according to claim 1, wherein the base layer further comprises a plurality of drainage openings extending between the fluid collection area and the lower surface, and wherein the absorbent layer is disposed between the lower surface of the base layer and the bottom layer beneath the drainage openings for collecting and holding fluids passing through the top layer, the fluid collection area, and the drainage openings. cm 3. A device for cushioning support of a body in seated or recumbent posture according to claim 2, wherein the base layer comprises a recess in the lower surface beneath the fluid collection area for receiving the absorbent layer.

4. A device for cushioning support of a body in seated or recumbent posture according to claim 1, wherein the absorbent layer is disposed within the fluid collection area.

5. A device for cushioning support of a body in seated or recumbent posture according to claim 1, wherein the foam of the base layer is of a cell structure substantially without affinity for fluid absorption or containment within the base layer.

6. A device for cushioning support of a body in seated or recumbent posture according to claim 5, wherein the foam of the base layer comprises a predominately closed cell foam.

7. A device for cushioning support of a body in seated or recumbent posture according to claim 6, wherein the foam of the base layer comprises an ethylene-vinyl acetate foam.

8. A device for cushioning support of a body in seated or recumbent posture according to claim 1, further comprising a plurality of layers of a spacer fabric overlying the upper surface, each layer of the spacer fabric having upper and lower fabric plys formed of predominately non-absorbent yarns in a fluid permeable fabric structure and an array of spacer segments formed of predominately non-absorbent yarns extending between the upper and lower plys and urging the upper and lower plys into spaced relationship to one another, for relatively free passage of fluids through the spacer fabric layers to the upper surface of the base layer,

9. A device for cushioning support of a body in seated or recumbent posture according to claim 8, wherein the spacer fabric layers comprise at least four layers of a spacer fabric.

10. A device for cushioning support of a body in seated or recumbent posture according to claim 1, wherein the base, absorbent, top and bottom layers are collectively configured as a seat cushion device for use on a chair seat.

11. A device for cushioning support of a body in seated or recumbent posture according to claim 10, wherein the upper surface of the base layer has a profiled configuration which comprises a recess configured for resting receipt of hips and thighs of the body.

12. A device for cushioning support of a body in seated or recumbent posture according to claim 11, wherein the profiled configuration of the upper surface of the base layer comprises spaced-apart convergingly inclined lateral hip support surfaces and a forward upper thigh support surface extending between forward ends of the hip support surfaces, with the fluid collection area disposed rearwardly of the upper thigh support surface and between rearward ends of the hip support surfaces, the fluid collection area being at a lower elevation than the upper thigh support surface and the hip support surfaces for receiving ischial tuberosities of the body when seated thereon.

13. A device for cushioning support of a body in seated or recumbent posture according to claim 12, wherein the lateral hip support surfaces are formed with recesses for promoting air exchange across and within the upper surface.

14. A device for cushioning support of a body in seated or recumbent posture according to claim 1, wherein the base, absorbent, top and bottom layers are collectively configured as a mattress device for use on a bed.

15. A device for cushioning support of a body in seated or recumbent posture according to claim 1, wherein the top and bottom layers are removable for cleaning.
